(19) United States
(12) Patent Application Publication
(10) Pub. No.: US 2008/0225392 A1
(43) Pub. Date: Sep. 18, 2008

(54) OPTICAL SYSTEM

(76) Inventor: Cheng-Hao KO, Zhudong Town (TW)

Correspondence Address: SINORICA, LLC, 528 FALLSGROVE DRIVE, ROCKVILLE, MD, 20850, US

(21) Appl. No.: 12/045,836

(22) Filed: Mar. 11, 2008

(30) Foreign Application Priority Data
Mar. 16, 2007 (TW) 096109036

(51) Int. Cl. G02B 5/18; G02B 1/10; G01J 3/00

(52) U.S. Cl. 359/570; 359/566; 359/569; 356/300

(57) ABSTRACT

The invention concerns an optical system. The optical system comprises an input for receiving an optical signal, a predetermined output plane, and a diffraction grating for separating the optical signal received at the input into spectral elements thereof. The grating has a diffraction surface with a first predetermined profile. The first profile is formed by a plurality of points each conducted by different equations. Consequently, each spectral component is focused on the predetermined plane.

### BACKGROUND OF THE INVENTION

1. Field of the Invention

The present invention relates to a novel diffraction grating and, more particularly, to a diffraction grating for being applied to an optical system.

2. Description of the Related Art

A spectrometer is typically implemented to measure photometry with regard to radiation sources, and a grating in such spectrometer is a component for dispersing a multi-frequency radiation. Instruments suchlike are extensively applied to deal with complex measurement tasks for acquiring accurate results. However, such instruments are currently disadvantageous by: (a) bulkiness resulted in great cost and using limitedly at fixed locations, (b) time consumption for wideband spectrum measurement, and (c) demand for skilled operators because cautious operation is necessary.

U.S. Pat. No. 5,550,375 provides an infrared-spectrometric sensor 100 for gases, as shown in FIG. 1, which comprises a microstructured body having a reflective grating 110, a multi-frequency IR radiation source 120, and a radiation receiver 130 for receiving IR of a fixed range of wavelength. Nevertheless, this infrared-spectrometric sensor is merely capable of measuring spectrums within a narrow wavelength range. In a case that multiple components are to be analyzed, the spectral signals would be absorbed at several different wavelengths, not only in the infrared region. Therefore, the applications of this prior spectrometric sensor are limited.

A simultaneous spectrometer 200 is another device for detecting radiation sources, as shown in FIG. 2. It comprises an entrance slit 200, a concave grating 210 capable of forming holographic images, and a photoelectric diode array 230. The aforementioned components are fixedly positioned and immovable while these components present the reliable advantages such as high accuracy and excellent optical efficiency. In such spectrometer, the photoelectric diode array is applied with limitations because the photoelectric diode array is substantially a flat plane, while the focuses of the spectrometer are distributed on a curved surface and, more particularly, on the Rowland circle. One preferred application of such simultaneous spectrometer is to increase the radius of the Rowland circle so that the distribution of the focuses can be a planar distribution approximately. However, this approach consumes large space and requires a large detector. An alternative solution is as the disclosure of U.S. Pat. No. 6,005,661, wherein a great quantity of optical fibers are employed to lead out signals with diverse wavelengths focused on the Rowland circle. Although such approach can compromise the disadvantages of photoelectric diode array, problems such as energy lost and degraded resolution may also occur when the focused signals are led out by the optical fibers.

Instead, a diffraction grating generating linear outputs is a preferable option for an optical system. As shown in FIG. 3A, the inventor of U.S. Pat. Nos. 4,695,132 and 4,770,517 provides a laser scanning system 300, which implements one or more fθ lenses 310 to focus scattered light beams on a linear output plane 320. As shown in FIG. 3B, U.S. Pat. No. 6,650,413 provides a spectrometer 301 using a diffraction grating 311 and comprising an assembly of a collimator 313 and a correcting lens 315 for focusing the output spectral components on an image plane 321 in accordance with an f sin(θ) distribution.

However, the above-mentioned inventions are all systems with complex structures and therefore fail to achieve the objective of microminiaturizing an optical system to become portable.

### SUMMARY OF THE INVENTION

It is one objective of the present invention to provide a diffraction grating for being applied to an optical system. The diffraction grating linearly distributes spectral components of all wavebands (including infrared, visible light and ultraviolet) on an image plane in accordance with the wavelength and can achieve desired image quality.

It is another objective of the present invention to provide an optical system with simple structure and microminiaturized volume that facilitates portability.

It is yet another objective of the present invention to provide an optical system, which can be mass-produced with reduced manufacturing costs and feasible for long-term use.

To achieve these and other objectives, the present invention provides the optical system that comprises an input for receiving an optical signal, a predetermined output plane, and a diffraction grating. The diffraction grating has a diffraction surface with a first profile. The first profile is formed by a plurality of points conducted by different equations for separating an optical signal received from the input into a plurality of spectral component so that the spectral components are focused on the predetermined output plane.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing illustrating a prior infrared-spectrometric detector,

FIG. 2 is a schematic drawing illustrating a prior simultaneous spectrometer,

FIG. 3A is a schematic drawing illustrating a prior laser scanning system,

FIG. 3B is a schematic drawing illustrating a prior spectrometer,

FIG. 4 is a sectional view of an optical system according to the present invention,

FIG. 5 is a schematic drawing of aforementioned optical system according the present invention,

FIG. 6 is a schematic drawing of another optical system according to the present invention,

FIG. 7 is a schematic drawing of a diffraction grating according to the present invention,

FIG. 8 is a schematic drawing showing an experimental system,

FIG. 9 is a comparison diagram of profiles of the exemplificative diffraction gratings,

FIG. 10A is a ray-tracing diagram according to a first embodiment of the present invention,

FIGS. 10B to 10D are spectrograms according to the first embodiment of the present invention,

FIG. 11A is a ray-tracing diagram according to a second embodiment of the present invention,

FIGS. 11B to 11D are spectrograms according to the second embodiment of the present invention,

FIG. 12A is a ray-tracing diagram according to a comparative example, and

FIGS. 12B to 12D are spectrograms according to the comparative example.

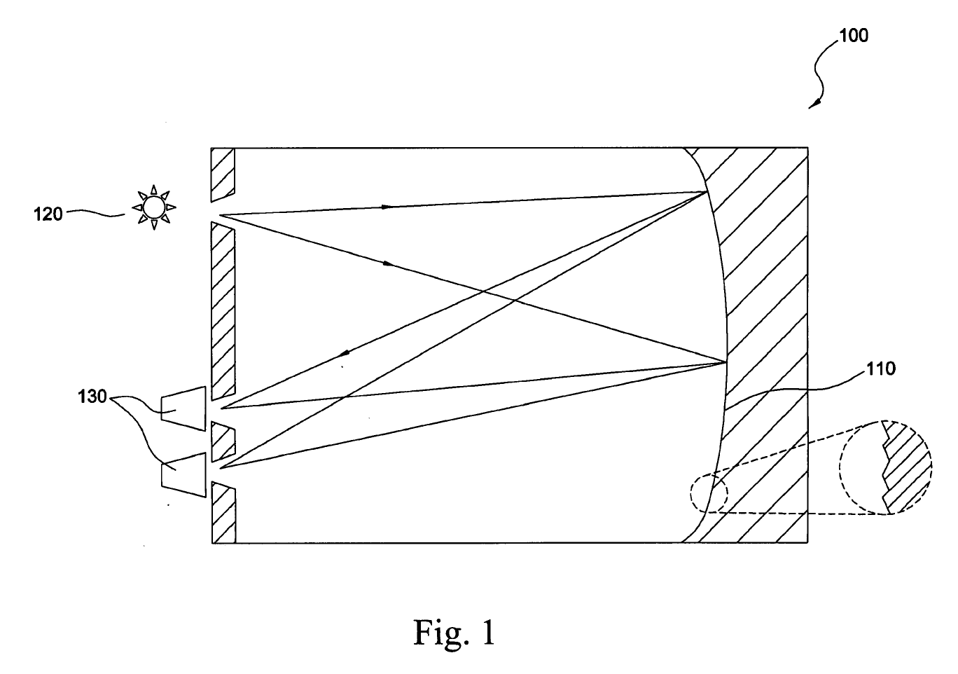

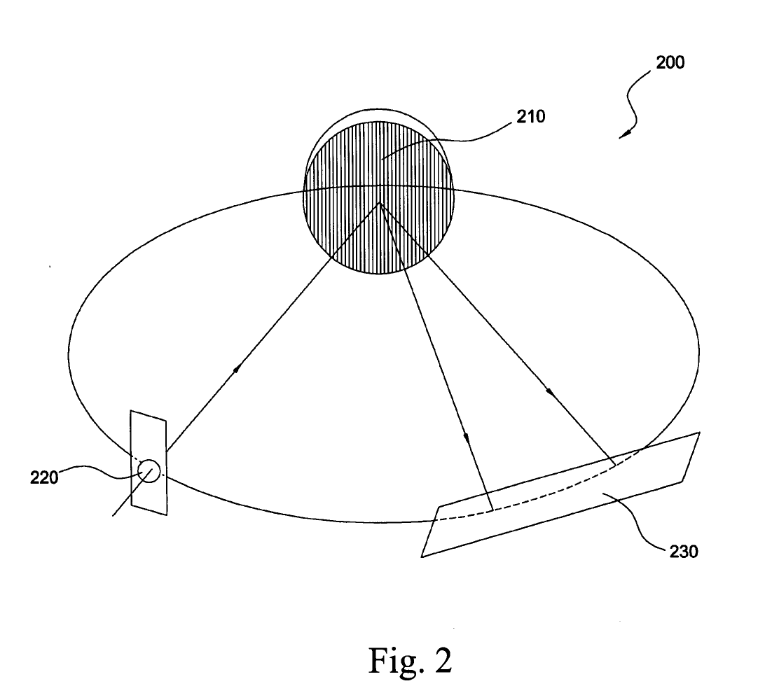

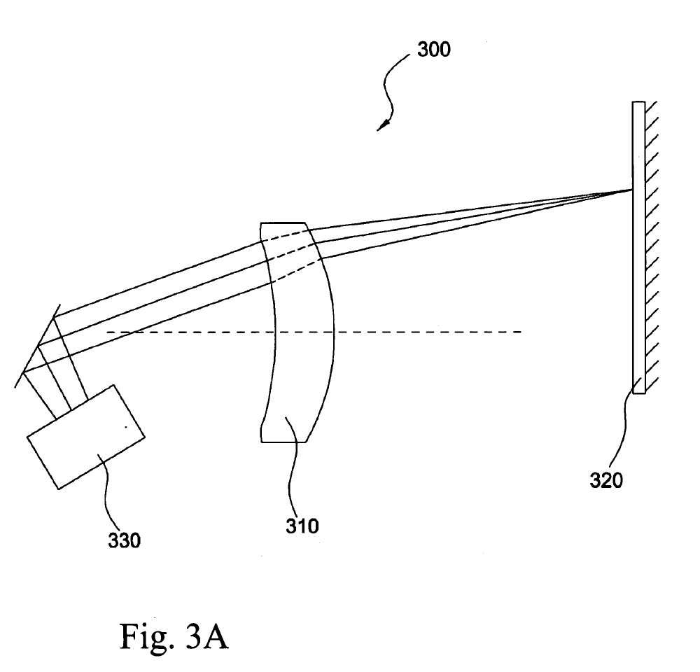

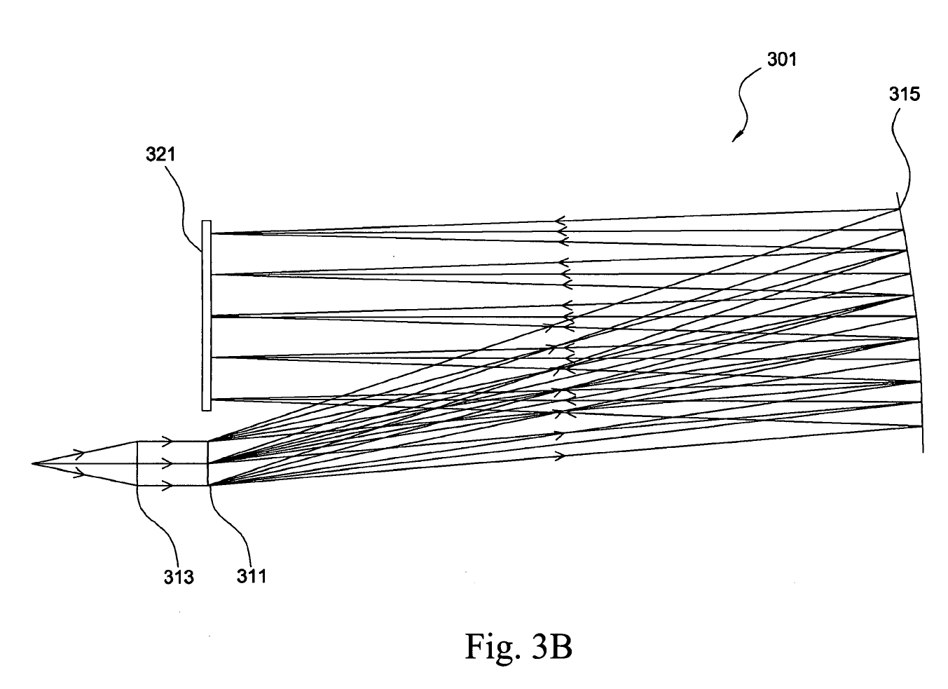

### DETAILED DESCRIPTION OF THE EMBODIMENTS

The technical features adopted in the present invention in attempt to achieve the aforementioned effects and objectives will be described in detail in company with particular embodiments and the accompanying drawing so as to be clearly comprehended.

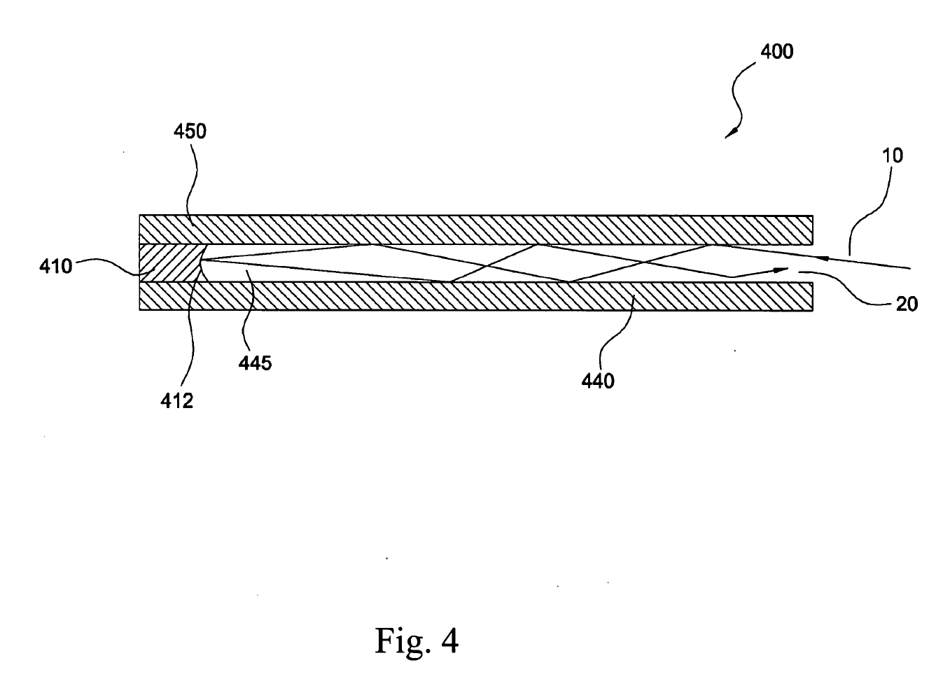

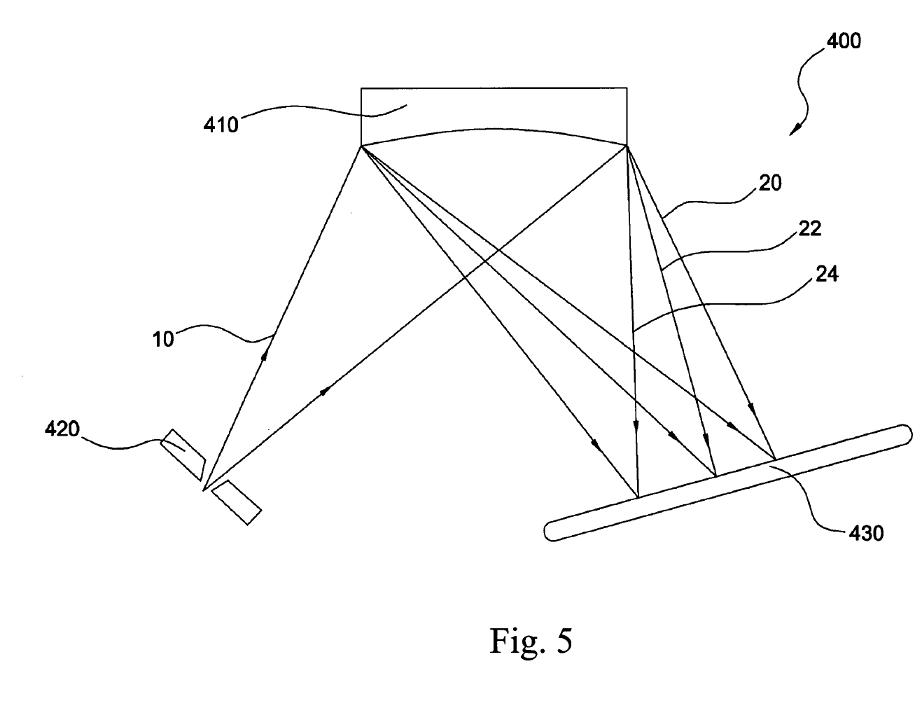

Please refer to FIGS. 4 and 5, wherein a preferred embodiment of the present invention is provided. Therein, an optical system 400 comprises a base 440, a cover 450, an input 420, a predetermined output plane 430, and a diffraction grating 410.

An inner space 445 is formed between the base 440 and the cover 450 and a plurality of spacers (not shown) may be sandwiched between the base 440 and the cover 450 to uphold the inner space 445 and separate the base 440 from the cover 450 for a desired distance. According to one preferred embodiment of the present invention, the diffraction grating 410 is settled on the base 440 and has a diffraction surface 412 that faces the inner space 445.

The input 420 is typically a slit wherethrough an optical signal 10 is allowed to enter the inner space 445. The input 420 may alternatively be an end of an optical fiber so that the optical signal 10 can be transmitted through the optical fiber into the inner space 445 of the optical system 400. According to one preferred embodiment of the present invention, the input of the optical system is a slit attached with an optical fiber, and the optical signal 10 can be transmitted via the optical fiber and then enter the optical system 400 through the slit from an end of the optical fiber.

The diffraction surface 412 is substantially concave, which has a first profile. The first profile is formed by a plurality of points and each location of these points is conducted by different optical path equations individually. A representation of the equations is F=ΣFᵢⱼₖwⁱl^{j}, which is a polynomial expansion. Therein, the parameters comprise the predetermined interval of the points, the entrance slit width, the incident arm length, the incident angle, the diffraction angle, the diffraction arm length, the spectral component resolution, the maximum resolving wavelength, the minimum resolving wavelength, the diffraction order, and the predetermined output plane.

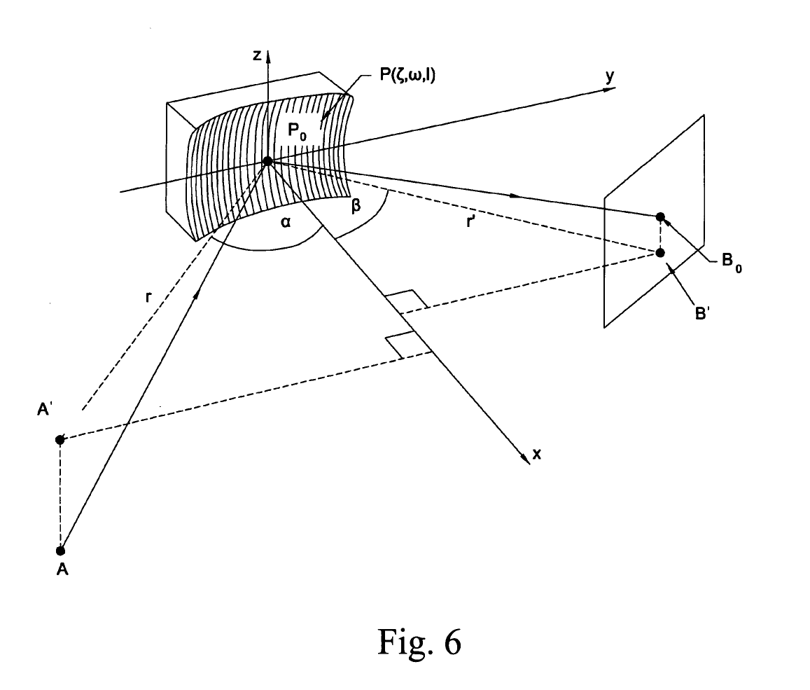

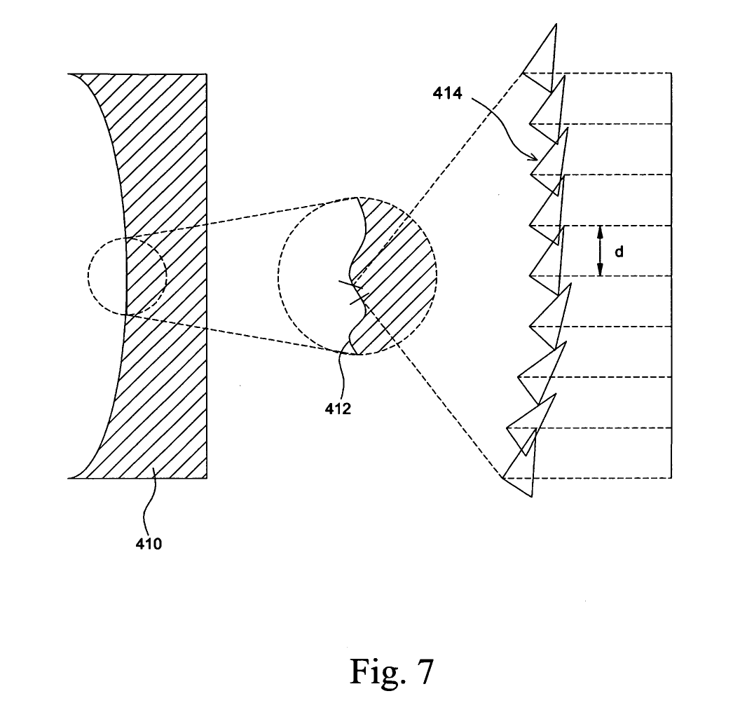

In FIG. 6 and FIG. 7, according to one preferred embodiment of the present invention, a diffraction grating 410 has a first profile 412 formed by a plurality of points P. Each P is represented by a coordinate (ξ, ω, l), wherein ξ, ω, and l are components of P at the x, y and z coordinate axes, respectively. Therein, the coordinate of P0 is set as (0, 0, 0). An optical signal A has a single wavelength, and a projective point A′ thereof on the x-y plane is away from P0 with a distance r, which is the incident arm length. An included angle between a line linking A′ and P0 and the x coordinate axis is the incident angle α. The optical signal A passes P0 and arrives a point B0 on the predetermined output plane. A projective point B′ of the point B0 on the x-y plane is away from P0 for a distance r′, which is the diffraction arm length. An included angle between a line linking B′ and P0 and the x coordinate axis is the diffraction angle β. By substituting the parameters, such as r, r′, α, β, the expected grating width, the expected resolution, the expected range of measuring wavelength, and entrance slit width, into the optical path equation, F=ΣFᵢⱼₖwⁱl^{j}, a plurality of equations related to the plural P points that form the first profile can be conducted and the coordinate of the first profile can be in turn derived.

In FIG. 7, the diffraction surface 412 further has a second profile 414 with a periodic structure, such as saw-toothed, wave-like, or rectangular. According to one preferred embodiment of the present invention, the diffraction surface 412 has a saw-toothed periodic structure wherein tops of the saw teeth are inclined at a fixed angle, and a vertical interval d between projections of the adjacent tooth tops is a grating pitch. One preferred embodiment of the present invention is as shown in FIG. 7, wherein the grating pitches are constant. Alternatively, the grating pitches may be variable. The second profile 414 is formed by a plurality of triangles. A line linking the pinnacles of the triangles constitutes the first profile. These triangles may be congruent triangles or incongruent triangles, wherein the inclined angles of the triangles are designed to optimize the diffraction efficiency for a specific diffraction order.

According to one preferred embodiment of the present invention, as shown in FIG. 5, the diffraction grating 410 is a reflective grating for separating the optical signal 10 entering the optical system 400 into a plurality of spectral components, such as 20, 22, and 24, which have different wavelengths. These spectral components are focused on the predetermined output plane in accordance with a linear distribution. When being focused, the FWHM (full width at half maximum) of the spectral components presented on the predetermined output plane is smaller than or equal to the predetermined wavelength resolution.

The predetermined output plane may be a flat plane or in any other geometric shape, such as a curved surface or a wavy surface. A detector is provided on the output plane to receive the focused spectral component signals. The detector is a light detector having a photoelectric diode array, such as a CCD (charge-coupled device) or a CMOS (Complementary Metal-Oxide-Semiconductor) image sensor.

The present invention may be embodied as the following described embodiments.

### Embodiment 1

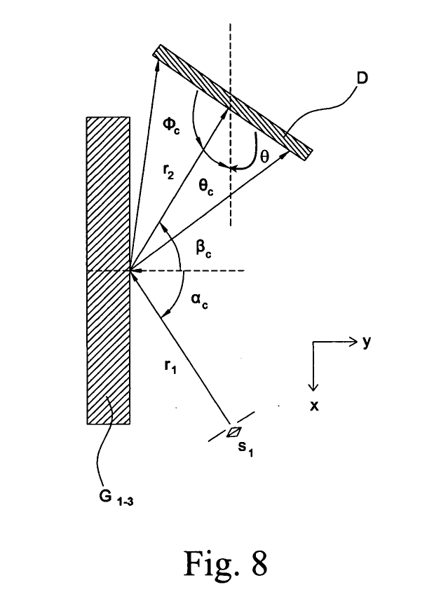

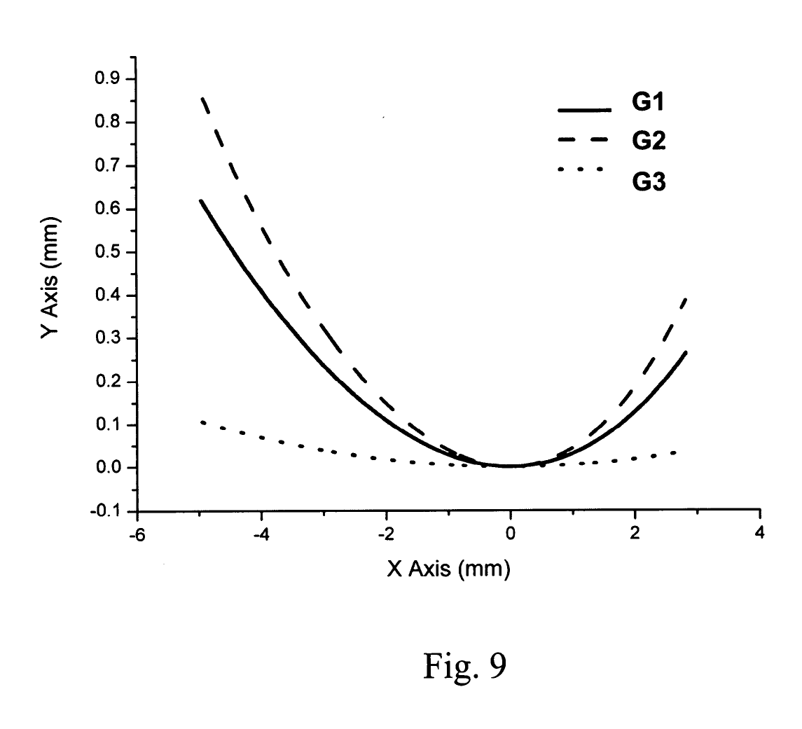

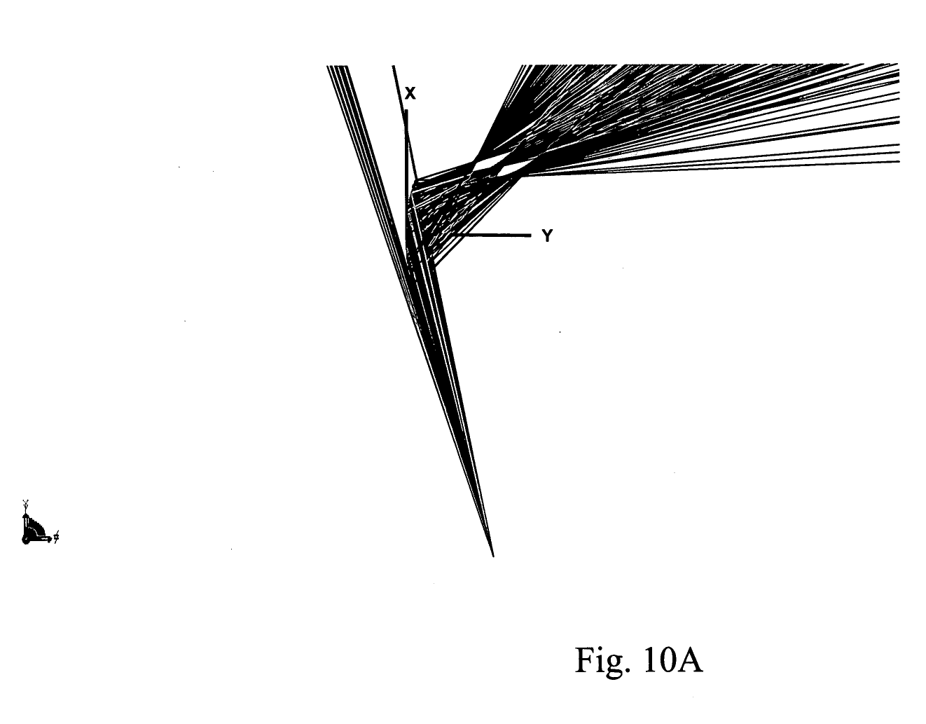

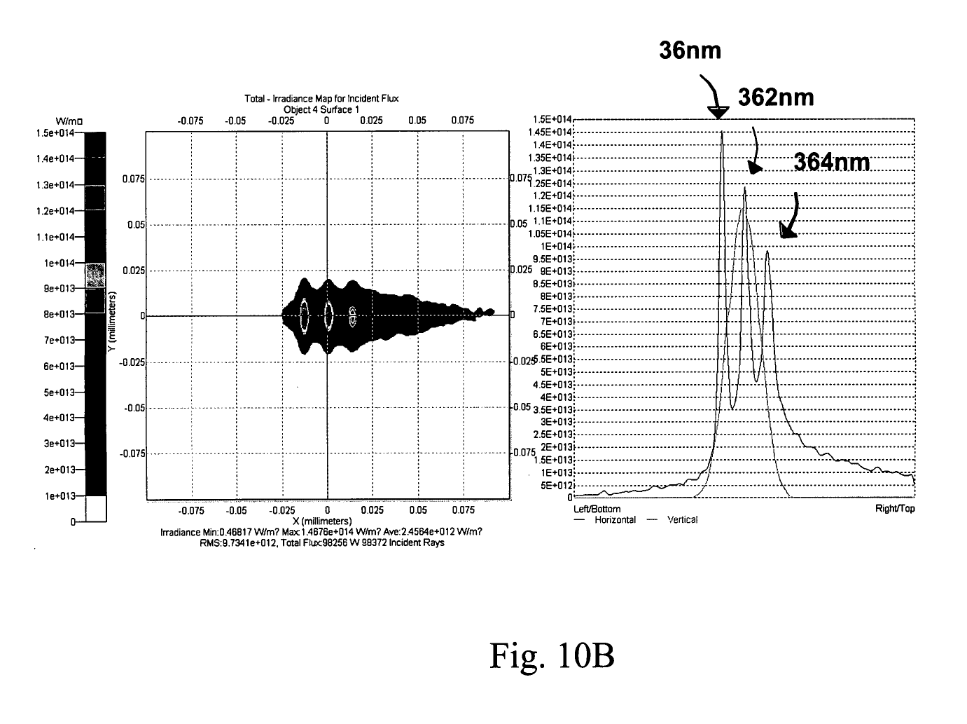

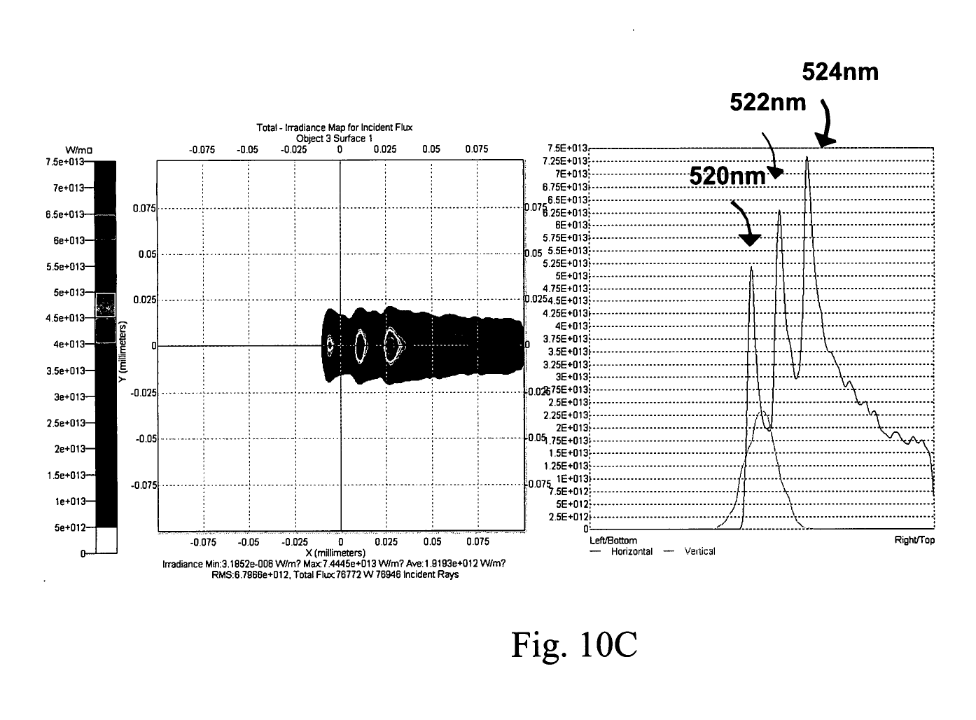

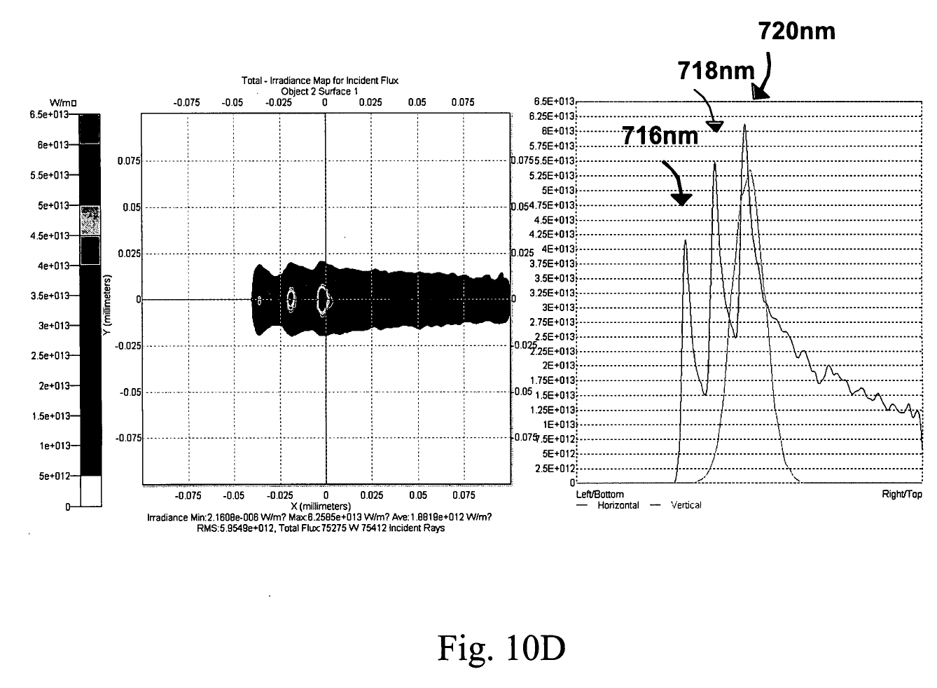

A grating G1 is provided with a profile as shown in FIG. 9. The experiment conditions are referred to FIG. 8, wherein the entrance slit width s₁=62.5 μm, the incident angle α_{c}=75°, the incident arm length r₁=30 mm, the diffraction order m=2, the grating interval d=3 μm, the grating G1 is placed on the x coordinate axis and the included angle θ between the planar detector D and the x coordinate axis is 69.3°. FIG. 10A exhibits the diffraction result of the grating G1, which is tested and derived by a ray-tracing software, Tracepro version 3.22, under these conditions. FIGS. 10B, 10C and 10D display the measuring results acquired by the detector D around 360 nm, 550 nm, and 720 nm, respectively. Thereupon, it is learned that the grating G1 reaches the resolution of 2 nm in the three wavelength ranges.

### Embodiment 2

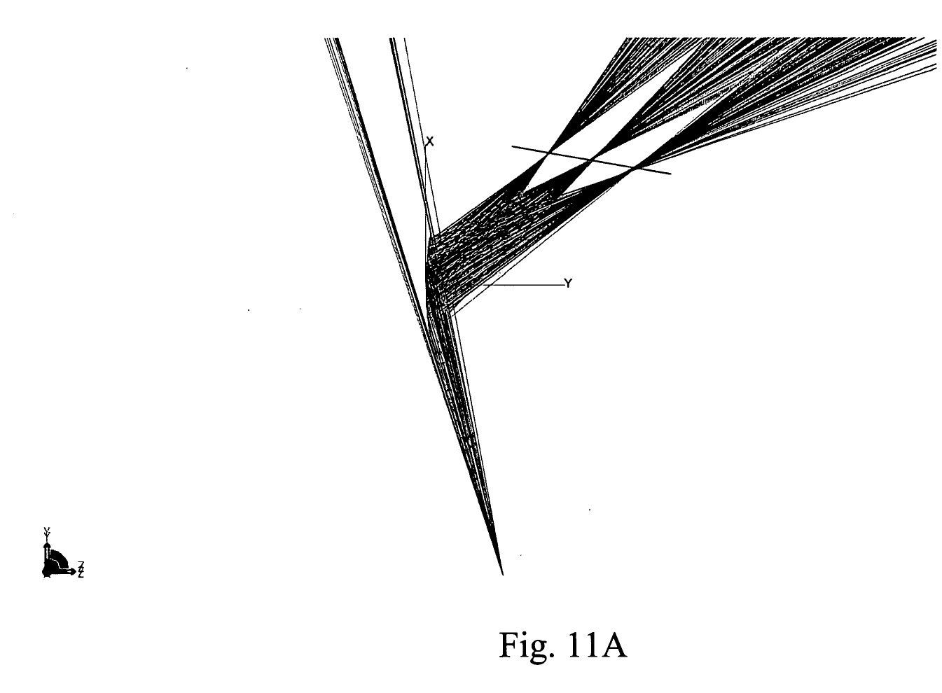

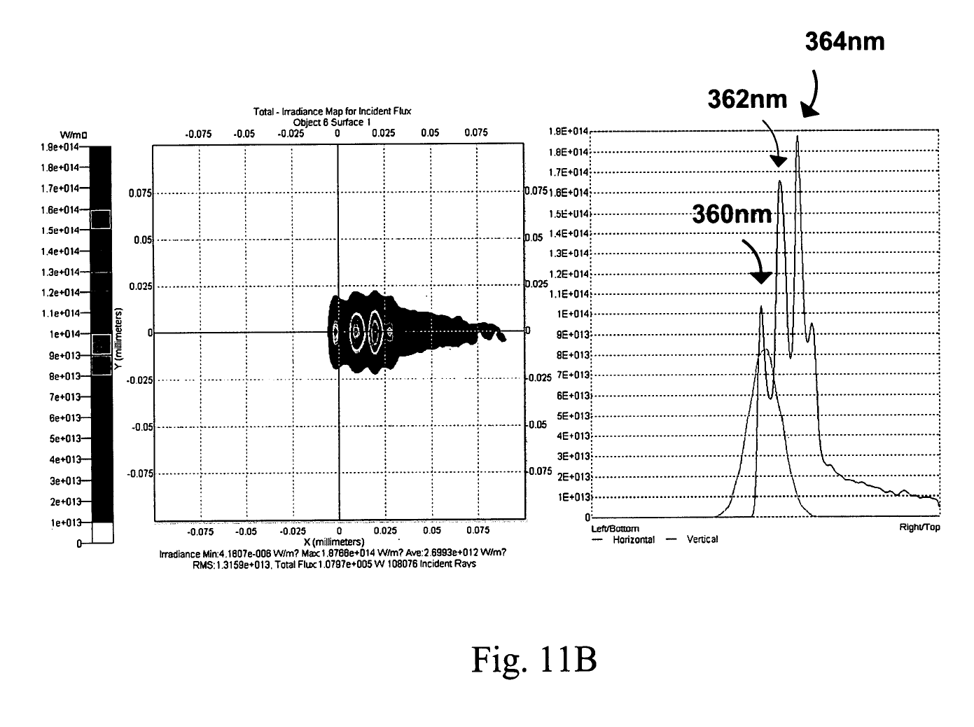

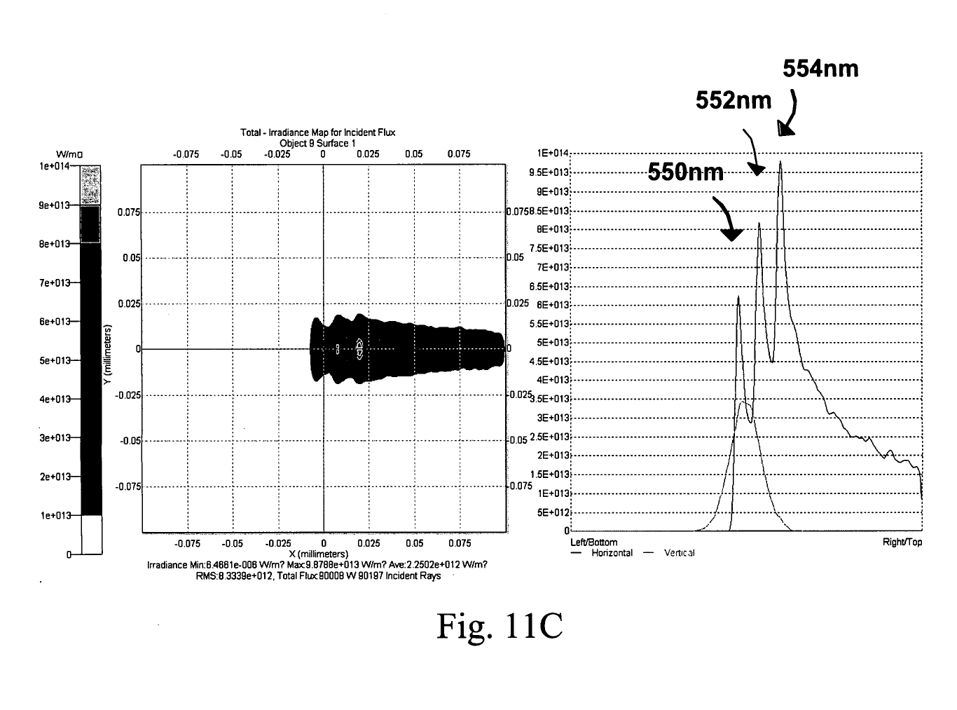

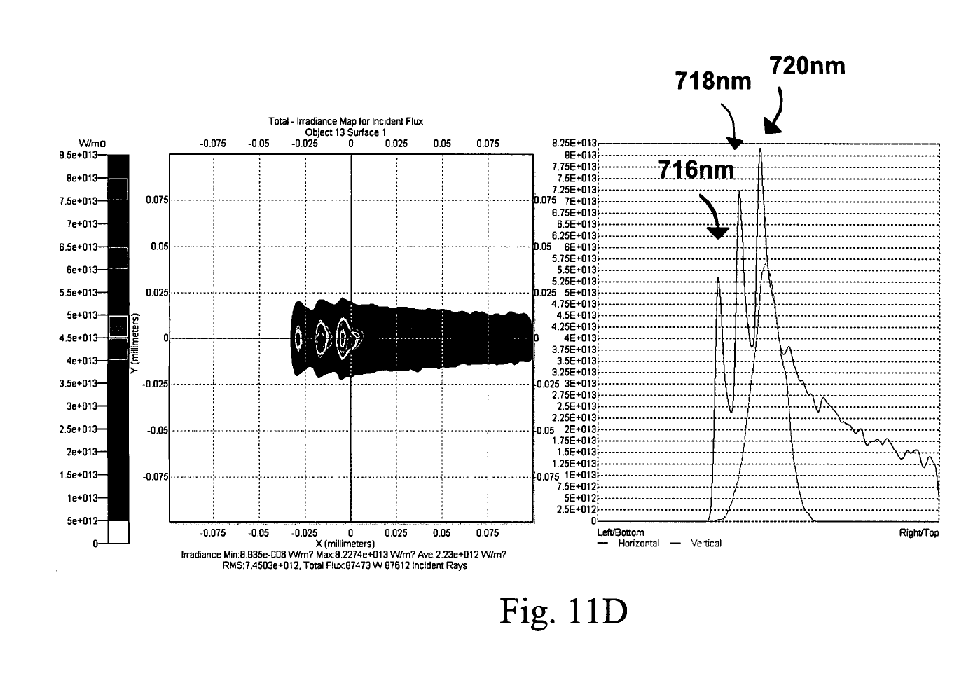

A grating G2 is provided with a profile as shown in FIG. 9. The experiment conditions are referred to FIG. 8, wherein the entrance slit width s₁=62.5 μm; the incident angle α_{c}=75°, the incident arm length r₁=30 mm, the diffraction order m=2, the grating interval d=3 μm, the grating G2 is placed on the x coordinate axis and the included angle θ between the planar detector D and the x coordinate axis is 80.5°. FIG. 11A exhibits the diffraction result of the grating G2, which is tested and derived by the ray-tracing software, Tracepro version 3.22, under these conditions. FIGS. 11B, 11C and 11D display the measuring results acquired by the detector D around 360 nm, 550 nm, and 720 nm, respectively. Thereupon, it is learned that the grating G2 reaches the resolution of 2 nm in the three wavelength ranges.

### Embodiment 3

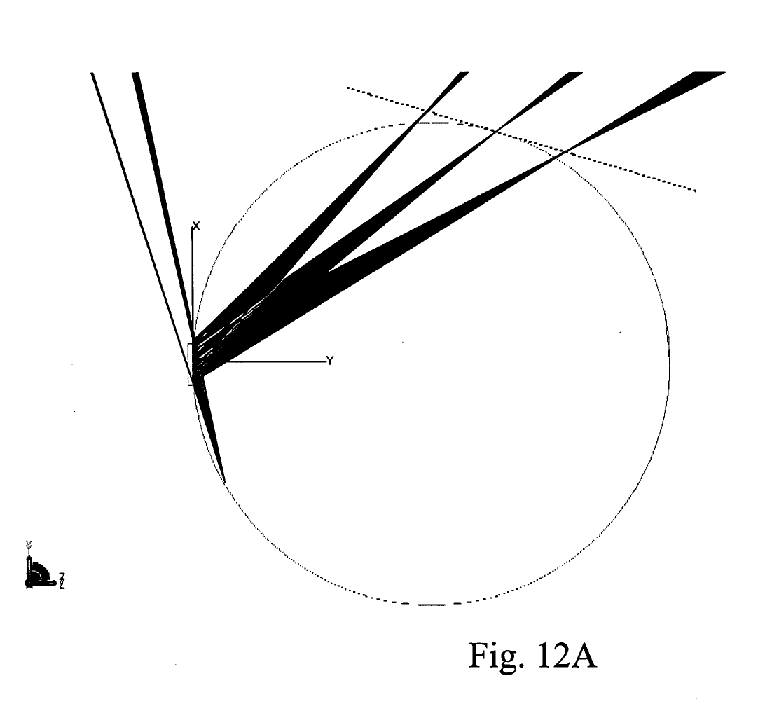

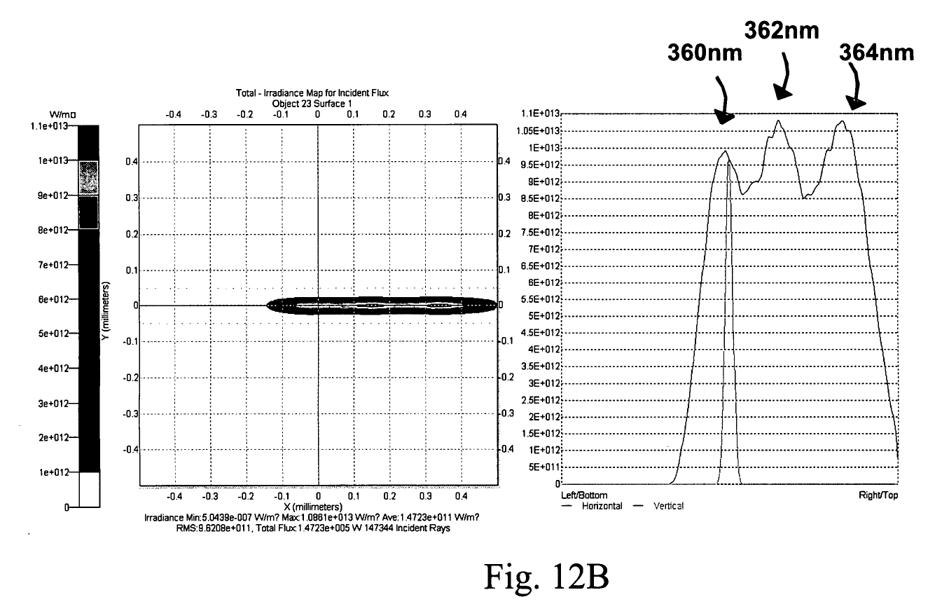

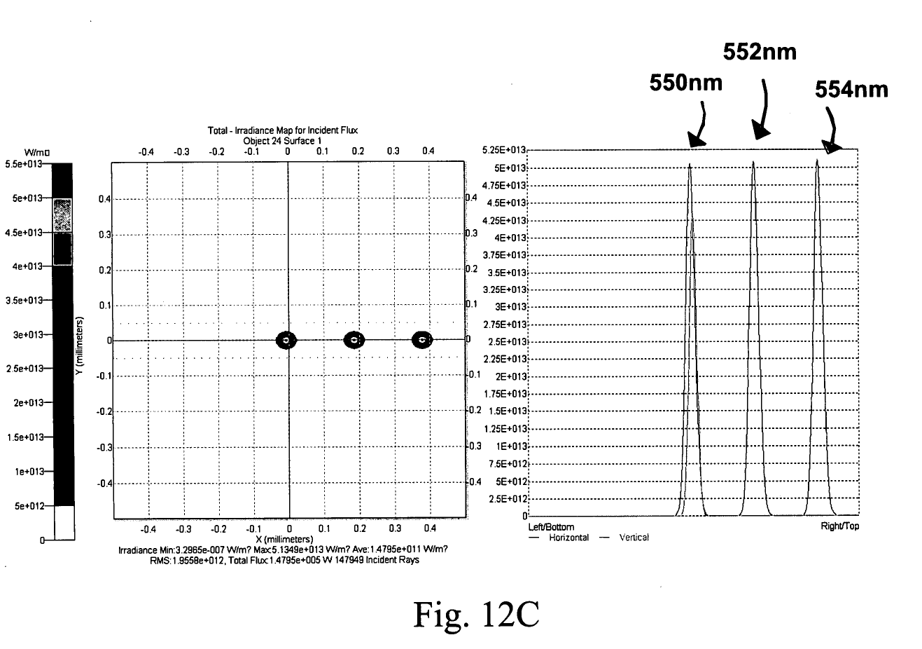

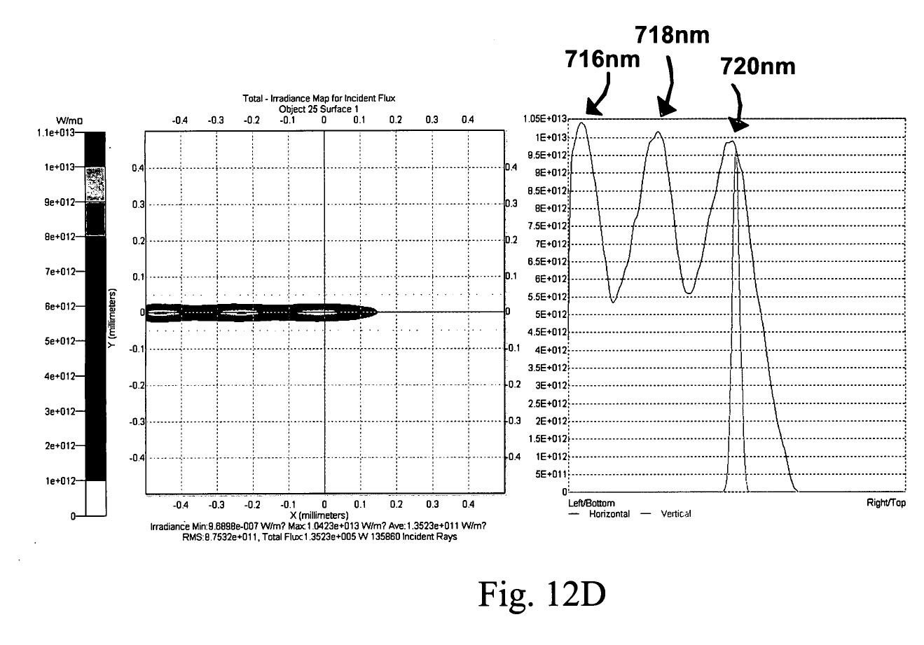

A grating G3 is provided with a profile as shown in FIG. 9 and is in accordance with the Rowland circle. The experiment conditions are referred to FIG. 8, wherein the entrance slit width s₁=62.5 μm, the incident angle α_{c}=75°; the incident arm length r₁=30 mm, the diffraction order m=2, the grating interval d=3 μm, the grating G3 is placed on the x coordinate axis and the included angle θ between planar detector D and the x coordinate axis is 73.64°. FIG. 12A exhibits the diffraction result of the grating G3, which is tested and derived by the ray-tracing software, Tracepro version 3.22, under these conditions. The resolution measurements are as illustrated in FIGS. 12B through 12D, wherein the resolution is not satisfying at the wavelength around 360 nm, and is perfect at the wavelength around 550 nm while the resolution is merely about 4 nm at the wavelength around 720 nm.

The comparison of the experiment results is tabled as Table 1. Therein, Φc is the included angle between the detector D and the spectral component and r₂ is the diffraction arm length. In the Embodiments 1 and 2, the diffraction arm lengths range from 8 to 12 mm, while in the Example 3 the grating G3 of the Rowland circle requires the diffraction arm length ranging form 80 to 105 mm. The results prove that the grating of the present invention is feasible to a microminiaturized optical system without extensive space.

TABLE 1

| | r₂(360 nm) | r₂(550 nm) | r₂(720 nm) | Φ_{c} | θ |
|---|---|---|---|---|---|
| G1 | 8.562 mm | 10.362 mm | 11.532 mm | 57.52° | 69.3° |
| G2 | 6.099 mm | 7.375 mm | 8.204 mm | 46.32° | 80.5° |
| G3 | 83.438 mm | 92.793 mm | 104.259 mm | 53.18° | 73.64° |

Hence, the diffraction grating of the present invention applied to an optical system can be constructed to meet a predetermined wavelength range and is feasible to spectrology of all wavebands (including X-ray, ultraviolet, visible light and infrared). The optical system is applicable to photometry and analysis for multi-component compounds so as to acquire complete measuring data.

The disclosed diffraction grating applied to an optical system can separate optical signals into a plurality of spectral components, so as to focus the spectral components on the linear plane without the need of lengthening the optical path. The disclosed diffraction grating provides functions of dispersion and focusing, so as to supersede collimators and correcting lenses. Therefore, the number of required components in the optical system can be reduced and consequently the optical system can be microminiaturized to accommodate in a portable optical instrument.

According to one preferred embodiment of the present invention, the optical system may be configured as a microstructure through a semiconductor process. Therein, the diffraction grating may be made by a lithography electroforming micro molding process or a lithography and etching process. Thereupon, through the present invention, the high accuracy as well as the mass production can be achieved and practical, resulting in reduced manufacturing costs and durable products.

Although the particular embodiments of the invention have been described in detail for purposes of illustration, it will be understood by one of ordinary skill in the art that numerous variations will be possible to the disclosed embodiments within the scope of the invention as disclosed in the claims.

What is claimed is:

1. An optical system, comprising:
an input, for receiving an optical signal,
a predetermined output plane, and
a diffraction grating, for separating the optical signal received at the input into a plurality of spectral components, which are all focused on the predetermined output plane.

2. The optical system of claim 1, wherein the predetermined output plane is a flat plane.

3. The optical system of claim 1, wherein the spectral components are distributed on the predetermined output plane in accordance with a linear distribution.

4. The optical system of claim 1, further comprising at least one detector provided on the predetermined output plane for detecting the spectral components focused on the predetermined output plane.

5. The optical system of claim 4, wherein the detector is a light detector.

6. The optical system of claim 1, wherein the input is a slit.

7. The optical system of claim 1, wherein the input is an end of an optical fiber.

8. The optical system of claim 1, wherein the diffraction grating is a reflective grating.

9. The optical system of claim 1, wherein the diffraction grating has a substantially concave diffraction surface.

10. The optical system of claim 1, wherein the diffraction grating has a diffraction surface having a saw-toothed profile.

11. An optical system, comprising:
an input, for receiving an optical signal;
a predetermined output plane, and
a diffraction grating, for separating the optical signal received at the input into a plurality of spectral components, wherein the diffraction grating has a diffraction surface with a first profile which is formed by a plurality of points conducted by different equations so that all the spectral components are focused on the predetermined output plane.

12. The optical system of claim 11, wherein the equations are derived by substituting a predetermined vertical interval of the points, a resolution, a maximum resolving wavelength, a minimum resolving wavelength, a diffraction order, a width of the entrance slit, and an equation of the predetermined output plane into a path equation, F=ΣFᵢⱼₖwⁱl^{j}, in which w and l are coordinate parameters.

13. The optical system of claim 11, wherein a second profile with a periodic structure is formed on the diffraction surface and tops of the periodic structure forms the first profile.

14. The optical system of claim 13, wherein the periodic structure is a saw-toothed structure.

15. The optical system of claim 14, wherein the tops of teeth of the saw-toothed structure have a fixed inclined angle.

16. An optical system, comprising:
a base,
a cover positioned above the base and forming an inner space together with the base,
a diffraction grating with a diffraction surface that faces the inner space,
an input for receiving an optical signal, and
a predetermined output plane settled in the optical system,
wherein the diffraction grating separates the optical signal received at the input into a plurality of spectral components, in which the diffraction surface of the diffraction grating has a first profile which is formed by a plurality of points conducted by different equations so that all the spectral components are focused on the predetermined output plane.

17. The optical system of claim 16 further comprising a plurality of spacers sandwiched between the base and the cover.

18. The optical system of claim 16, wherein the diffraction grating is settled on the base.
